(19) United States
(12) Patent Application Publication
(10) Pub. No.: US 2004/0039129 A1
(43) Pub. Date: Feb. 26, 2004

(54) Non-pressurized methods for the preparation of conjugrated solid supports for boronic acids

(76) Inventor: Dennis G. Hall, Edmonton (CA)

Correspondence Address: DANN, DORFMAN, HERRELL & SKILLMAN, 1601 MARKET STREET, SUITE 2400, PHILADELPHIA, PA, 19103-2307, US

(21) Appl. No.: 10/344,778

(22) PCT Filed: Aug. 16, 2001
(86) PCT No.: PCT/CA01/01172

(51) Int. Cl. C08F 112/08

(52) U.S. Cl. 525/333.3

(57) ABSTRACT

The methods of the invention are directed to preparation of dihydroxyalkylaminoalkyl-conjugated solid supports, such as a diethanolamine- or a dipropanolamine-conjugated resin or polystyrene under non-pressurized conditions. The invention also provides novel methods for immobilizing boronic acids. The invention also provides a novel class of solid supports comprising dihydroxyalkyl-aminoalkyl groups

### TECHNICAL FIELD

This invention generally relates to the fields of chemistry and pharmaceutical drug preparation. In particular, the invention is directed to dihydroxyalkylaminoalkyl and dihydroxyaminobenzyl-conjugated solid supports and non-pressurized methods for their formation.

### BACKGROUND OF THE INVENTION

Boronic acids, such as arylboronic acids, are important reagents in the synthesis of a variety of commercially useful compounds, including pharmaceutical compositions. They are employed in a variety of biological applications such as carbohydrate recognition (for recent reviews see, e.g., Wulff, Pure Appl. Chem. 1982, 2093-2102; James et al., Angew. Chem. Int. Ed. Engl. 1996, 35, 1910-1922). Also, arylboronic acids can be crucial synthetic intermediates or potential inhibitors of therapeutically relevant serine protease enzymes (for recent examples see, e.g., Kettner et al., J. Biol. Chem. 1984, 259, 15106; Martichonok et al., J. Am. Chem. Soc. 1996, 118, 950-958; Tian et al.; J. Org. Chem. 1997, 62, 514-522; Zhong et al., J. Am. Chem. Soc. 1995, 117, 7048; Priestley et al., Org. Lett. 2000, 2, 3095-3097). Boronic acids have also been applied in neutron capture therapy for cancer (for reviews see, e.g., Barth et al., Sci. Am. 1990, 263, 68-73; Hawthorne, Angew. Chem. Int. Ed. Engl. 1993, 32, 950-984; Mehta et al., Pharm. Res. 1996, 13, 344-351; Soloway et al., Chem. Rev. 1998, 1515-1562), and as transmembrane transport agents (for a recent review, see, e.g., Smith et al., Adv. Supramol. Chem. 1999, 5, 157-202 and references cited therein).

In recent years, boronic acids have also gained tremendous popularity as substrates and building blocks in organic synthesis and combinatorial chemistries. They have found widespread use in Suzuki cross-coupling reactions (see, e.g., Suzuki, Organometal Chem.1999, 576, 147-168; Suzuki, A., in “Metal-catalyzed Cross-coupling Reactions”, Eds. Diederich, F., et al., Wiley-VCH, 1997, Chapt. 2). They can also provide novel biphenyl units, such as those represented in several biologically active molecules (see, e.g., Duncia (1992) Medical Research Reviews 12:149). Many new types of synthetic transformations have created a demand for the commercial availability of a larger number of functionalized boronic acids.

However, in spite of the demand for boronic acids, particularly arylboronic acids, and conjugated forms of these compounds, there remains a shortage of commercially available supplies. A recent review of a number of commercial suppliers of chemicals revealed that there were less than 150 boronic acids commercially available, as compared to a few thousand carboxylic acids, and several hundreds of different alcohols, just to name a few. The paucity of boronic acids can be explained by the non-existence of natural ones, and in large part by difficulties associated with the synthesis and derivatization of even the simplest functionalized ones by solution phase methods.

The isolation of compounds containing a boronic acid functionality can prove notoriously troublesome due to their amphiphilic character. They exist as water-soluble tetrahedral boronate anions at high pH and are thought to be hydrated at neutral pH (see, e.g., Lorand, J. Org. Chem. 1959, 24, 769-774), so that even those bearing a relatively hydrophobic group can be difficult to extract quantitatively into organic solvents under standard aqueous work-up procedures. These problems are amplified when the desired boronic acid-containing compound comprises other sites with basic or acidic functionalities. Boronic acids are also typically slow moving on silica gel, and consequently must often be purified by recrystallization. In addition, although arylboronic acids are relatively stable and can be handled without special precautions, alkylboronic acids, and to some extent alkenylboronic acids are sensitive to oxidation even under ambient air (see, e.g., Snyder et al., J. Am. Chem. Soc. 1938, 60, 105-111; Matteson, J. Am. Chem. Soc. 1960, 82, 4228-4233). Some of these problems can be alleviated by protection of the boronic group as an ester (see, e.g., Matteson, D. S. Stereodirected Synthesis with Organoboranes, Springer: 1995, Berlin, Heidelberg, p. 17 (section 1.4.2). However, these approaches require additional synthetic operations.

In view of all the above mentioned impediments in handling boronic acids by solution phase methods, it is clear that a simple and general solid-phase approach for their immobilization and derivatization would be of tremendous usefulness. Indeed, solid-phase methods circumvent the need for aqueous work-up and other time-consuming operations required to isolate the desired boronic acid from excess reagents and by-products.

A solid support for the immobilization of boronic acids is an N,N-diethanolaminomethyl polystyrene support (“DEAM-PS”) (see, e.g., Hall et al., Angew. Chem. Int. Ed. 1999, 38, 3064-3067). DEAM-PS can be employed to efficiently immobilize and transform functionalized boronic acids (e.g., arylboronic acids) using, e.g., amide coupling, acylation, and reductive amination methods. DEAM-PS resin facilitates the synthesis of new arylboronic acids. DEAM-PS can be used in the large-scale purification of arylboronic acids. DEAM-PS is useful in resin to resin transfer reactions, such as in Suzuki cross-coupling reactions. The resultant biphenyl products can be used to produce pharmaceutical agents.

One potential limitation to producing solid supports capable of immobilizing boronic acids, such as DEAM-PS, particularly to producing it on a large-scale basis, is the rigorous conditions required to form such solid supports.

Hall describes the need for ethylene oxide and consequent pressurized conditions in the synthesis of DEAM-PS from aminomethyl polystyrene (Hall, Angew. Chem. 1999, 38, 3064-3067).

Others have reported the use of high temperatures in the production of various amine functionalized solid supports.

WO97/42230 describes the synthesis of an aminodiol- and morpholine-derivatized polystyrene resin using high temperatures and inert atmosphere reaction conditions. The reaction of diethanolamine with Merrifield resins at high temperatures has been reported in Che et. al, Chinese Journal of Synthetic Chemistry 1998, 6, 69-74, and Che et. al, Journal of Molecular Catalysis (China), 1998, 12, 148-151.

Similarly, the reaction of primary and secondary amines not having hydroxyl groups in their structure with Merrifield resins at elevated temperatures has been reported in the literature. The reaction of piperazine and Merrifield resin in dioxane at a reaction temperature of 70° C. was reported by Hird et al. in Tetrahedron Letters, 1997, 38, 7111-7114, while the reaction of ethylene diamine with Merrifield resin at 50° C. under an inert atmosphere was reported by Stangier and Hindsgaul in SYNLETT, 1996, 179-181. Further examples of reaction of such primary and secondary amines with Merrifield resins at elevated temperatures can be found in the following publications: Marx et al., J. Am. Chem. Soc. 1997, 119, 6153-6167; Conti et. al, Tetrahedron Letters 1997, 38, 2915-2918; Adrian et. al, Tetrahedron 1998, 54, 3581-3588.

The reaction of arylamines with chloromethylated Wang resin at 90° C. was reported by Raju and Kogan in Tetrahedron Letters 1997, 38, 4965-4968.

Accordingly, what is needed is a novel class of bis-functionalized dihydroxyalkylaminoalkyl-conjugated or dihydroxyaminobenzyl-conjugated solid supports capable of immobilizing boronic acids and methods for making same in high homogeneity and yields, which methods do not require high temperatures or pressures.

### SUMMARY OF THE INVENTION

This invention provides methods for preparing a dihydroxyalkylaminoalkyl- (e.g., a diethanolaminoalkyl-, or dipropanolaminoalkyl-) or a dihydroxybenzylamino-conjugated solid support under non-pressurized conditions comprising the following steps: (a) providing an alkyl halide or a substituted alkyl halide or a benzyl halide conjugated to a solid support, wherein the alkyl halide has a formula —CH₂)ₘ—X and m is an integer between 1 to about 20, and X is the halide and is chloride, bromide, iodide or an equivalent thereof; (b) providing a composition comprising a secondary amine comprising two hydroxyalkyl substituents, wherein the composition has a formula HO(CH₂)ₓHN(CH₂)_{y}OH and x and y are integers between 1 to about 20; (c) providing a halide salt selected from the group consisting of a bromide salt, an iodide salt, or an equivalent thereof; and, (d) mixing the conjugated solid support of step (a) with the composition of step (b) and the halide salt of step (c) under non-pressurized conditions, thereby forming a dihydroxyalkylaminoalkyl-conjugated solid support.

In alternative embodiments of the method, the dihydroxyalkylaminoalkyl-moiety is a dihydroxyaminobenzyl-group, a dihydroxyalkylaminomethyl-group, a dihydroxyalkylaminoethyl-group, a dihydroxyalkylaminopropyl-group, or a dihydroxyalkylaminobutyl-group. The alkyl halide of step (a) can be methylchloride (ClCH₂—) or ethylchloride; methyl bromide (BrCH₂—) or ethyl bromide; methyl iodide (ICH₂—) or ethyl iodide. The alkyl group of step (a) preferably comprises the formula —(CH₂)ₘ—, wherein m is an integer between 1 to about 5.

The substituted alkyl halide may be substituted by a C₁-C₈ alkyl or an aryl group. It is preferred that the x and y integers range from about 2 to 20, more preferably 2 to 5.

In other embodiments, the composition of step (b) can be diethanolamine, or dipropanolamine, or diisopropanolamine. The composition of step (b) can be diluted in solution, for example, at a concentration of between about 0.1 M to about 2M. The composition of step (b) can be added as an undiluted or substantially undiluted solution. The composition of step (b) can be in a solution, e.g., a solution comprising N-methylpyrrolidinone. The composition of step (b) can be added to the mixture of step (d) such that the initial number of equivalents, e.g. 5-20 equivalents of amine is in excess of the number of equivalents of alkyl halide or substituted alkyl halide or benzyl halide of step (a). Alternatively, the initial number of equivalents of amine of step (b) can be about equivalent to the number of equivalents of alkyl halide or substituted alkyl halide or benzyl halide of step (a) and a base is additionally added to the mixture of step (d). In a preferred embodiment, the base is diisopropylethylamine, or a carbonate salt, or an equivalent thereof. In a preferred embodiment, the reaction takes place at room temperature.

In one embodiment, the halide salt of step (c) can be added to the mixture of step (d) such that the initial amount of halide salt in the mixture is equimolar to or ten times the amount of alkyl halide or substituted alkyl halide or benzyl halide of step (a). Alternatively, the halide salt of step (c) can be added to the mixture of step (d) such that the initial amount of halide salt in the mixture on a molar basis is two to five times the amount of alkyl halide or alkyl substituted halide or benzyl halide of step (a). In one embodiment, the halide salt of step (c) can be a sodium iodide, or a tetraalkylammonium iodide, or a bromide salt or an equivalent. In other embodiments, the halide salt can comprise a lithium halide, a potassium halide, a cesium halide, or a tetraalkylammonium halide.

In a preferred embodiment; suitable solvents include polar aprotic solvents, for example, N-methylpyrrolidinone, THF, DMSO, and equivalents thereof.

Generally, the solid support of step (a) may be a plastic or a plastic copolymer or an equivalent thereof.

More particularly, the solid support of step (a) can comprise a polyphenol, a polyvinyl, a polypropylene, a polyester, a polyethylene, a polyethylene glycol, a polyethylene, a polystyrene-copolymer, or an equivalent thereof, or a mixture thereof.

In one preferred embodiment, the solid support of step (a) comprises a polystyrene or an equivalent composition. The polystyrene can comprise a poly(styrene-divinylbenzene) (PS-DVB) or an equivalent composition. In another embodiment, the solid support of step (a) can comprise a POEPOP (polyoxyethylene/polyoxypropylene copolymer) or a SPOCC (superpermeable organic combinatorial chemistry resin).

The solid support of step (a) can comprise a poly(vinyl alcohol) (PVA) hydrogel or an equivalent composition. 1% PS-DV6 is an example of this type of support.

The solid support of step (a) can comprise a polyacrylamide or an equivalent polymer composition. The polyacrylamide can comprise a polymethacylamide, a methyl methacrylate, a glycidyl methacrylate, a dialkylaminoalkyl-(meth)acrylate, or a N,N-dialkylaminoalkyl(meth)acrylate, or an equivalent composition.

Alternatively, the solid support of step (a) can comprise an inorganic composition selected from the group consisting of sand, silica, silica gel, glass, glass fibers, gold, alumina, zirconia, titania, and nickel oxide and combinations thereof and equivalents thereof.

The solid support may be preferably a silica or a silica gel or a cellulose or a cellulose acetate. In a more preferred embodiment, the solid support may comprise a polystyrene-polyethylene glycol copolymer, e.g. Tantagel® or Argogel®.

In one embodiment, the solid supports of the invention further comprise a boronic acid attached as a boronic ester-dihydroxyalkylaminoalkyl-conjugated support. The boronic acid can be an aryl boronic acid.

In one embodiment, the dihydroxyalkylaminoalkyl- (e.g., diethanolaminoalkyl-) conjugated group is covalently bonded to the solid support through a spacer group or a linker group. The spacer group can be an aryl-silane linker group.

In alternative embodiments, the mixing of step (d) can last for about 6, about 12, about 24, or about 48 hours or longer. The mixing time can vary according to the number of equivalents of secondary amine added relative to the alkyl halide or substituted alkyl halide or benzyl halide conjugated to the solid support. The mixing of step (d) can last from about 12 to about 48 hours. The mixing of step (d) can take place at about room temperature, or, it can take place at a temperature of from about 20 to 25° C.

The method can further comprise washing the solid support of step (d) at least once with at least one solvent. The solvent can comprise tetrahydrofuran, methylene chloride, dimethylformamide, dimethylsulfoxide, methanol, ethanol, or an equivalent thereof or a mixture thereof. The method also can further comprising washing the dihydroxyalkylaminoalkyl-conjugated solid support of step (d) with a tetrahydrofuran solution followed by washing with a methylene chloride solution.

In one embodiment of the method of the present invention, the dihydroxyalkylaminoalkyl-conjugated polystyrene is made by a process comprising the following steps: (a) swelling the polystyrene with N-methyl-2-pyrrolidone (NMP) before reaction with the dihydroxyalkylamine; (b) mixing the dihydroxyalkylamine and the halide salt with the swelled polystyrene.

In an alternative embodiment of the method, the invention provides a method for preparing a conjugated solid support under non-pressurized conditions comprising the following steps: (a) providing a solid support conjugated with a primary amino group; (b) providing a composition comprising a haloalcohol comprising a primary, secondary or tertiary hydroxy substituent and a primary or secondary halogen substituent; (c) providing a halide salt or an equivalent thereof; and, (d) providing a base; and (e) mixing the conjugated solid support of step (a) with the composition of step (b) and the halide salt of step (c) and the base of step (d) under non-pressurized conditions, thereby forming a dihydroxyalkylaminoalkyl or a dihydroxyaminobenzyl-conjugated solid support. In a preferred embodiment, the halogenated alcohol comprises 2-chloroethanol, 2-bromoethanol, or 2-iodoethanol. In one preferred embodiment, the base added to the reaction is DIPEA, or carbonate, or an equivalent thereof. Acid is generated during the reaction, thereby slowing down the reaction, and/or decreasing yield.

The invention also provides a method than can be utilized in both the solid phase and solution phase for coupling a dihydroxyalkylamine with an alkyl or benzyl halide with the use of a halide salt, wherein the halide salt is an iodide salt or a bromide salt, or an equivalent thereof. In situ transformation of the alkyl or benzyl halide to the halide of the halide salt followed by subsequent displacement of the halide by a dihydroxyalkylamine (e.g., diethanolamine) at room temperature affords a tertiary dihydroxylalkylaminoalkyl compound. While these conditions are promoted by an iodide (or equivalent) ion, they do not necessitate any pressure or any rise of temperature.

The invention also provides a novel class of solid supports comprising dihydroxyalkylaminoalkyl or dihydroxyaminobenzyl groups. These compositions are particularly useful for immobilizing boronic acids for use in solid phase chemical reactions, e.g., solid-phase synthesis, such as those used in combinatorial chemistries. For example, the compositions and methods of the invention are also useful as “scavenger” or “fishing out” solid supports, e.g., in solution-phase parallel synthesis of small molecule libraries.

The invention provides a solid support derivatized with a dihydroxyalkylaminoalkyl group, wherein the dihydroxyalkylaminoalkyl comprises a tertiary amine having two hydroxyalkyl substituents having a formula HO(CH₂)ₓN (CH₂)_{y}OH, wherein x and y are integers between 1 to about 20. In preferred embodiments, the amine comprises a diisopropoxy amine, or a dihydroxyethylamine, or a dihydroxypropylamine, or dihydroxybutylamine, or dihydroxpentylamine. Alternative embodiments include a dihydroxyalkylaminomethyl group, or a dihydroxyalkylaminobenzyl group or a dihydroxyalkylaminoethyl, a dihydroxy-alkylaminopropyl, or a dihydroxyalkylaminobutyl group.

The invention also provides a method for making a solid-supported boronic acid ester comprising the following steps: (a) providing a conjugated solid support prepared by the following steps: (i) providing an alkyl halide or a substituted alkyl halide or a benzyl halide conjugated to an solid support, wherein the alkyl halide has a formula —(CH₂)ₘ—X and m is an integer between 1 to about 20, and X is the halide and is chloride, bromide, iodide, or an equivalent thereof; (ii) providing a composition comprising a secondary amine comprising two hydroxyalkyl substituents, wherein the composition has a formula HO(CH₂)ₓHN (CH₂)_{y}OH and x and y are integers between 1 to about 20; (iii) providing a bromide or iodide salt, or an equivalent thereof; and, (iv) mixing the conjugated solid support of step (i) with the composition of step (ii) and the halide salt of step (iii) under non-pressurized conditions, thereby forming a dihydroxyalkylaminoalkyl-conjugated solid support; (b) providing a boronic acid solution; and, (c) mixing the dihydroxyalkylaminoalkyl-conjugated solid support of step (a) with the boronic acid solution of step (b), thereby forming a bound boronic acid ester. In a preferred embodiment, the solvent of the solution of step (b) comprises non-alcoholic, anhydrous THF. In other embodiments, the solvent comprises an equivalent non-alcoholic anhydrous solvent.

The invention also provides a method for immobilizing a boronic acid comprising the following steps: (a) providing a conjugated solid support prepared using by following steps: (i) providing an alkyl halide or a substituted alkyl halide or a benzyl halide conjugated to an solid support, wherein the alkyl halide has a formula —(CH₂)ₘ—X and m is an integer between 1 to about 20, and X is the halide and is chloride, bromide, iodide or an equivalent thereof; (ii) providing a composition comprising a secondary amine comprising two hydroxyalkyl substituents, wherein the composition has a formula HO(CH₂)ₓHN(CH₂)_{y}OH and x and y are integers between 1 to about 20; (iii) providing a, bromide or iodide salt, or an equivalent thereof; and, (iv) mixing the conjugated solid support of step (i) with the composition of step (ii) and the halide salt of step (iii) under non-pressurized conditions, thereby forming a dihydroxyalkylaminoalkyl-conjugated solid support; (b) providing a boronic acid solution; and, (c) mixing the dihydroxyalkylaminoalkyl-conjugated solid support of step (a) with the boronic acid solution of step (b), thereby immobilizing the boronic acid. In a preferred embodiment, the solvent of the solution of step (b) comprises non-alcoholic, anhydrous THF. In other embodiments, the solvent comprises an equivalent non-alcoholic anhydrous solvent.

The invention also provides a method for preparing a conjugated resin comprising the following steps: (a) providing an alkyl halide or a substituted alkyl halide or a benzyl halide conjugated to a resin, wherein the alkyl halide has a formula —(CH₂)ₘ—X and m is an integer between 1 to about 20, and the halide is chloride, bromide, iodide or an equivalent thereof; (b) providing a composition comprising a secondary amine comprising two hydroxyalkyl substituents, wherein the composition has a formula HO(CH₂)ₓHN(CH₂)_{y}OH and x and y are integers between 1 to about 20; (c) providing a halide salt selected from the group consisting of a, a bromide salt, an iodide salt and an equivalent thereof; and, (d) mixing the conjugated solid support of step (a) with the composition of step (b) and the halide salt of step (c) under non-pressurized conditions, thereby forming the conjugated resin.

The invention also provides a method for preparing conjugated polystyrene beads comprising the following steps: (a) providing an alkyl halide or a substituted alkyl halide or a benzyl halide conjugated to a polystyrene bead, wherein the alkyl halide has a formula —(CH₂)ₘ—X and m is an integer between 1 to about 20, and X is the halide and is chloride, bromide, iodide or an equivalent thereof; (b) providing a composition comprising a secondary amine comprising two hydroxyalkyl substituents, wherein the composition has a formula HO(CH₂)ₓ HN(CH₂)_{y}OH and x and y are integers between 1 to about 20; (c) providing a halide salt selected from the group consisting of a bromide salt, an iodide salt and an equivalent thereof, and, (d) mixing the conjugated bead of step (a) with the composition of step (b) and the halide salt of step (c) under non-pressurized conditions for about 24 to about 48 hours, thereby forming the dihydroxyalkylaminoalkyl or dihydroxyaminobenzyl-conjugated polystyrene beads.

The solid supports of the invention can comprise any combination, or mixture of different dihydroxyalkylaminoalkyl groups. The solids supports of the invention can also comprise any mixture of materials, e.g., a column of beads comprising different polystyrenes, or other materials.

The invention also provides a use of an iodide or bromide salt for the production under non-pressurized conditions of a conjugated solid support from an alkyl halide, a substituted alkyl halide or a benzyl halide and a secondary amine comprising two hydroxyalkyl substituents, wherein the composition has a formula HO(CH₂)ₓHN(CH₂)_{y}OH and x and y are integers between 1 to about 20.

The details of one or more embodiments of the invention are set forth in the accompanying drawings and the description below. Other features, objects, and advantages of the invention will be apparent from the description and drawings, and from the claims.

All publications, patents and patent applications cited herein are hereby expressly incorporated by reference for all purposes.

### BRIEF DESCRIPTION OF DRAWINGS

FIG. 1 is a schematic of the embodiment of the invention as described in detail in FIG. 1.

FIG. 2 is a schematic summarizing the immobilization of boronic acids as discussed in detail in Example 5.

FIG. 3a shows the gel-proton phase proton NMR spectra of the free form of DEAM-PS, while FIG. 3 B shows the NMR spectra of the p-tolylboronic acid conjugated form using a magic angle spinning nanoprobe.

### DETAILED DESCRIPTION OF THE INVENTION

The invention provides a novel class of conjugates and a novel non-pressurized means to prepare such conjugates, such as an N,N-diethanolaminomethyl polystyrene, under pressure-free conditions. The methods of the invention also do not require any rise in temperature. Preferably, the methods are practiced at room temperatures. Other temperature conditions may be selected and would be apparent to a person skilled in the art. Thus, these conjugates can be prepared without use of a special reaction vessel. The methods of the invention are extremely practical and provide a conjugate (e.g., an N,N-diethanolaminomethyl polystyrene) of high homogeneity at high yields. The reaction of bis functionalized compounds with derivatized polystyrene in high homogeneity are particularly useful and the present methods are especially adaptable for the preparation of large quantities of materials.

The invention provides solid supports derivatized with for example dihydroxy-alkylaminoalkyl groups. The solid supports can be of any material that can be derivatized with or coupled to dihydroxyalkylaminoalkyl groups. For example, in one embodiment, the solid support is a polystyrene, e.g., a dihydroxyalkylaminoalkyl-conjugated resin, such as diisopropanolamine derivatized polystyrene or diethanolaminomethyl derivatized polystyrene. The solid support can be in any form, e.g., as a bead, a filament, a porous material, and the like.

The invention also provides novel methods for making and using the solid supports of the invention. Solid supports of the invention, e.g., DEAM-PS, can be employed to efficiently immobilize and transform functionalized boronic acids (e.g., arylboronic acids, vinyl boronic acids, and the like). Solid supports of the invention can be used to immobilize boronic acids for use in any reaction involving boronic acids or derivatives thereof, such as for amide coupling, acylation, or reductive amination methods (see e.g., Mann (1999) Org. Lett. 1:379-381; Jurisson (1995) Nucl. Med. Biol. 22:269-281). Solid supports of the invention can be used to “scavenge” or “fish out” a boronic acid from a sample, particularly a sample comprising a complex mixture of chemicals. “Scavenging” is a reaction in solution-phase with a molar excess of a boronic acid as reagent (e.g., a solid support of the invention comprising a dihydroxyalkylaminoalkyl group, as compared to the amount of boronic acid in the sample. The reaction generates a boronic acid-free solution.

The dihydroxyalkylaminoalkyl-derivatized solid supports of the invention are particularly useful in combinatorial chemistries, as discussed in detail, below. They are also useful for stabilizing boronic acids from oxidation by air. Accordingly, the compositions of the invention can be used to store boronic acids, particularly, those sensitive to oxidation. They allow for the straightforward attachment and cleavage of boronic acids under mild conditions. They can serve to immobilize several types of functionalized boronic acids. Several options are available following the solid-phase derivatization of an dihydroxyalkylaminoalkyl-derivatized solid supported boronic acid. The resulting product can be released either as a free boronic acid, or through a modifying cleavange procedure such as oxidation to form a phenol derivative (see, e.g., Carboni et al., Tetrahedron Lett. 1999, 40, 7979-7983; Pourbaix et al., Chem. Commun. 2000, 1275-1276; Pourbaix et al., Org. Lett. 2001, 3, 803-806). Alternatively, in cases where the new boronic acid is a substrate for a subsequent reaction, it is actually possible to strealine the supported substrate into a resin-to-resin transfer reaction (RRTR) (see, e.g., Thompson and Hall, Chem. Commun. 2000, 2379-2380; Gravel et al., J. Comb. Chem. 2000, 2, 228-231). By avoiding cleavage and transfer operations, this type of multi-resin system is particularly attractive towards automated library synthesis.

In addition to these applications, the derivatized solid supports could also be useful as solid-supported scavengers or as supports for affinity purification of boronic acids (see, e.g., Hall et al., Angew Chem. Int. Ed. 1999, 38, 3064-3067; International Patent Application No. WO97/42230 to Bolton et al.).

Diethanolamine adducts have long been employed to stabilize, purify, and characterize boronic acids (see, e.g., Tripathy and Matteson, Synthesis, 1990, 200-206). In one embodiment, as described in Example 1, below, polystyrene resin was derivatized with a diethanolamine anchor. This was achieved through the reaction of Merrifield resin with an excess of diethanolamine in the presence of excess sodium iodide at room temperature. The resulting diethanolamine-derivatized resin possessed characteristics and a loading level that demonstrated the clean and complete amination of chlorobenzylated polystyrene to give DEAM-PS.

Example 5 describes the immobilization of p-tolylboronic acid in high yields by esterification with DEAM-PS, through simple mixing for less than 1 hour in anhydrous solvents at room temperature. As expected from the behavior of diethanolamine boronates in solution phase (Letsinger, R. L.; Skoog, I. J. Am. Chem. Soc. 1955, 77, 2491-2494; Tripathy, P. B.; Matteson, D. S. Synthesis 1990, 200-206), there was no need to drive the reaction forward by exhaustive trapping of the water released in this immobilization process. This constitutes a significant advantage over other types of diols, whether solid-supported or not, which usually require azeotropic removal of the water (Carboni, B.; Pourbaix, C.; Carreaux, F.; Deleuze, H.; Maillard, B. Tetrahedron Lett. 1999, 40, 7979-7983; Pourbaix, C.; Carreaux, F.; Carboni, B.; Deleuze, H. Chem. Commun. 2000, 1275-1276; Pourbaix, C.; Carreaux, F.; Carboni, B. Org. Lett. 2001, 3, 803-806; Li, W.; Burgess, K. Tetrahedron Lett. 1999, 40, 6527-6530; Dunsdon, R. M.; Greening, J. R.; Jones, P. S.; Jordan, S.; Wilson, F. X. Bioorg. Med. Chem. Lett. 2000, 10, 1577-1579). Coupling p-tolylboronic acid with a commercially available polystyrene-supported glycerol was found to have a much lower efficiency, thus highlighting the importance of the nitrogen atom from the diol anchor of the hydroxyalkylaminoalkyl-conjugated resins.

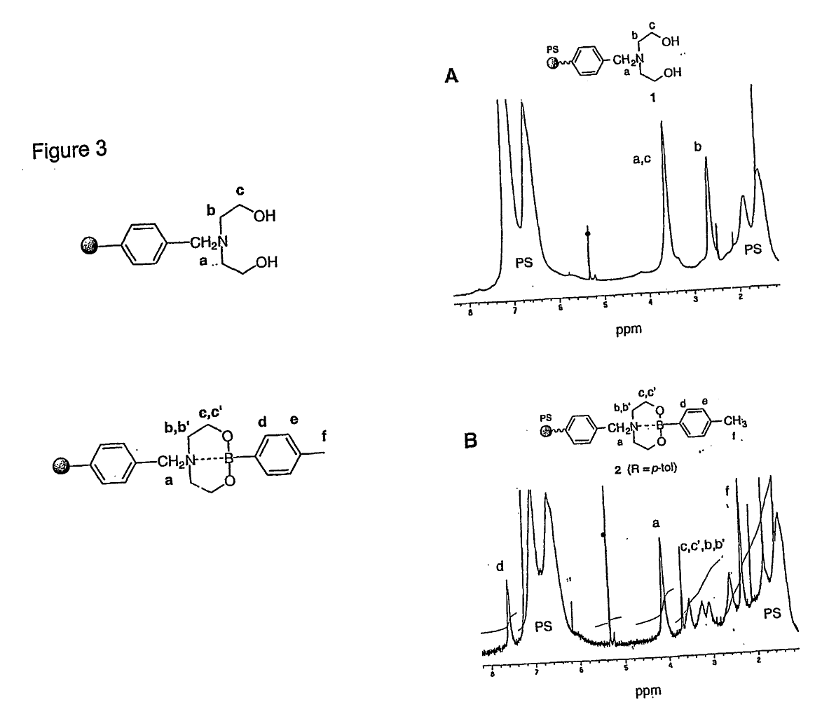

In order to access the efficiency and ease with which a dihydroxyalkylaminoalkyl conjugate couples with boronic acids, the role of the diethanolamine nitrogen in the polymer-supported case was explored. In Example 7, the gel phase proton NMR spectra of the free form of DEAM-PS and the p-tolylboronic acid conjugated form using a magic angle spinning nanoprobe was obtained (FIGS. 3a and 3b).

Definitions

Unless defined otherwise, all technical and scientific terms used herein have the meaning commonly understood by a person skilled in the art to which this invention belongs. As used herein, the following terms have the meanings ascribed to them unless specified otherwise.

As used herein, the term “alkyl” is used to refer to a branched or unbranched, saturated or unsaturated, open chain or cyclic, hydrocarbon radical having from 1 to about 20 carbons, or, from about 4 to about 20 carbons, or, from about 6 to about 18 carbons. When the alkyl group has from 1 to about 6 carbon atoms, it can be referred to as a “lower alkyl.” Suitable alkyl radicals include, for example, structures containing one or more methylene, methine and/or methyne groups. The term also includes branched structures have a branching motif similar to i-propyl, t-butyl, i-butyl, 2-ethylpropyl, etc. As used herein, the term encompasses “substituted alkyls.” “Substituted alkyl” refers to an alkyl as just described including one or more functional groups such as lower alkyl, aryl, acyl, halogen (i.e., alkylhalos), hydroxy, amino, alkoxy, alkylamino, acylamino, thioamido, acyloxy, aryloxy, aryloxyalkyl, mercapto, thia, aza, oxo, both saturated and unsaturated cyclic hydrocarbons, heterocycles and the like. These groups may be attached to any carbon of the alkyl moiety. Additionally, these groups may be pendent from, or integral to, the alkyl chain.

The term “boronic acid” includes any form of boronic acid or equivalent, including, e.g., aryl boronic acids, such as such as phenylboronic acids; see also, U.S. Pat. Nos. 6,083,903; 6,075,126; 6,037,490; 6,031,117; 6,013,783; 5,840,677; 5,780,454; 5,739,318. Boronic acid reagents and boronic acid complexing reagents are described in, e.g., U.S. Pat. Nos. 5,594,111, 5,623,055, 5,668,258, 5,648,470, 5,594,151, 5,668,257, 5,677,431, 5,688,928, 5,744,627, 5,777,148, 5,831,045 and 5,831,046.

As used herein, the term “resin” refers to any insoluble polymeric material which allows ready separation from liquid phase materials by filtration and which can be used to carry library members or reagents, or to trap excess reagents or reaction by-products (i.e. scavenger resin).

As used herein the term “solid support” refers to insoluble, functionalized, polymeric material to which library members or reagents may be attached (often via a linker) allowing them to be readily separated (e.g. by filtration, centrifugation, etc.) from excess reagents, soluble reaction by-products or solvents.

As used herein, the term “non-pressurized” refers to reaction conditions wherein the pressure in the reaction vessel is substantially the same as the pressure of the surrounding atmosphere exterior to the vessel. The methods of the present invention can be carried out in a variety of vessels, e.g., round-bottom flasks, erlenmeer flasks.

As used herein, the terms “mixing or “contacting” refer to the act of bringing components of a reaction into adequate proximity such that the reaction can occur. More particularly, as used herein, the terms “mixing” and “contacting” can be used interchangeably with the following: combined with, added to, mixed with, passed over, flowed over, etc.

General Methods

The present invention provides conjugates and methods for preparing conjugates under non-pressurized conditions. The skilled artisan will recognize that the methods of the invention can be practiced using a variety of ancillary and equivalent procedures and methodologies, which are well described in the scientific and patent literature., e.g., Organic Syntheses Collective Volumes, Gilman et al. (Eds) John Wiley & Sons, Inc., New York; Venuti (1989) Pharm Res. 6:867-873. The invention can be practiced in conjunction with any method or protocol known in the art, which are well described in the scientific and patent literature. Therefore, only a few general techniques will be described prior to discussing specific methodologies and examples relative to the novel methods of the invention.

Solid Substrate Surfaces

The methods of the invention comprise providing an alkyl halide or a substituted alkyl halide or a benzyl halide conjugated to a solid support, or an amine conjugated to a solid support. Any solid support which can be directly or indirectly conjugated to an alkyl halide or a substituted alkyl halide, or a benzyl halide, or an amine can be used. The solid support should be chemically robust, and substantially insoluble under conditions for practicing the methods of the invention. The solid support can be of a rigid, semi-rigid or flexible material. The solid support can be flat or planar, be shaped as wells, raised regions, etched trenches, pores, beads, filaments, or the like.

Solid support can be of any material upon which an alkyl halide or a substituted alkyl halide, or a benzyl halide, or an amine can be directly or indirectly bound. For example, suitable materials can include, e.g., resins, such as polystyrenes or equivalent compositions (see, e.g., U.S. Pat. Nos. 5,290,819; 5,525,637; 591,778; 5,880,166; 5,900,146). The polystyrene can comprise a poly(styrene-divinylbenzene) (PS-DVB) or an equivalent composition. The solid support can comprise a plastic or a plastic co-polymer (Nylon™, Teflon™) or an equivalent thereof. The solid support can comprise a polyphenol, a polyvinyl, a polypropylene, a polyester, a polyethylene, a polyethylene glycol, a polystyrene-copolymer, or an equivalent thereof, or a mixture thereof. The solid support can comprise a poly(vinyl alcohol) (PVA) hydrogel. The solid support can comprise a polyacrylamide or an equivalent polymer composition. The polyacrylamide can comprise a polymethacylamide, a methyl methacrylate, a glycidyl methacrylate, a dialkylaminoalkyl-(meth)acrylate, or a N,N-dialkylaminoalkyl(meth)acrylate, or an equivalent composition. The solid support can comprise an inorganic composition selected from the group consisting of sand, silica gel, glass (see, e.g., U.S. Pat. No. 5,843,767), glass fibers (see, e.g., U.S. Pat. No. 6,053,012), metals (e.g., gold, alumina, zirconia, titania, and nickel oxide). Other solid support alternatives include ceramics, quartz or other crystalline substrates (e.g. gallium arsenide), metalloids, polacryloylmorpholide, poly(4-methylbutene), poly(ethylene terephthalate), rayon (see, e.g., U.S. Pat. No. 5,609,957), nylon, poly(vinyl butyrate), polyvinylidene difluoride (PVDF) (see, e.g., U.S. Pat. No. 6,024,872), silicones (see, e.g., U.S. Pat. No. 6,096,817), polyformaldehyde (see, e.g., U.S. Pat. Nos. 4,355,153; 4,652,613), cellulose, cellulose acetate (e.g., polyvinyl acetate, see, e.g., U.S. Pat. No. 5,900,146), nitrocellulose, various membranes and gels (e.g., silica aerogels, see, e.g., U.S. Pat. No. 5,795,557), paramagnetic or superparamagnetic microparticles (see, e.g., U.S. Pat. No. 5,939,261) and the like. The surface can be derivatized for application of the alkyl halide or a substituted alkyl halide or equivalents. Reactive functional groups can be, e.g., hydroxyl, carboxyl, amino groups or the like. The solid support can also comprise a gel-type polymer.

In one embodiment, the solid support is a plurality of conjugated beads or bundles of conjugated fibers, e.g., a column of conjugated resin beads.

Combinatorial Chemistries

The dihydroxyalkylaminoalkyl-derivatized solid supports are particularly useful in combinatorial chemistries. For example, the solid supports of the invention can be used to immobilize boronic acids, e.g., aryl boronic acids. The solid supports of the invention can be used to immobilize aryl, alkenyl, and alkyl boronic acids and functionalized boronic acids near quantitatively in a wide range of organic solvents. Methods, reagents and apparatus for practicing combinatorial chemistries are well known in the art, see, e.g., U.S. Pat. Nos. 6,096,496; 6,075,166; 6,054,047; 5,980,839; 5,917,185; 5,767,238.

### EXAMPLES

The following examples are offered to illustrate, but not to limit the claimed invention.

### Example 1

### Preparation of an N,N-diethanolaminomethyl Polystyrene

The following example describes an exemplary protocol for practicing the methods of the invention to prepare a stable, resin-bound boronic ester in the form of an N,N-diethanolaminomethyl polystyrene (DEAM-PS) under non-pressurized, room temperature conditions.

Chloromethylated polystyrene (as a standard 1% divinylbenzene (DVB) cross-linked Merrifield resin) is transformed in situ to the iodide derivative, which is displaced by excess diethanolamine in a minimum quantity of N-methylpyrrolidinone at room temperature. While these conditions are promoted by an iodide (or equivalent) ion, they do not necessitate any pressure nor any rise of temperature. This new protocol provides DEAM-PS resin of high homogeneity and can be readily adapted to the preparation of large quantities of product, e.g., on a kilogram scale.

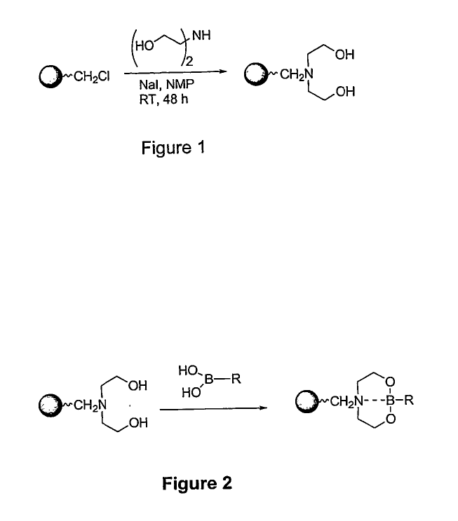

In FIG. 1, a dihydroxyalkylaminoalkyl-conjugated polystyrene solid support was made by a process comprising the following steps. Merrifield resin (1% divinylbenzene, 3.34 gram; 2.11 mmol. At 0.63 mmol./gram) was swelled with 35 mL of N-methyl-2-pyrrolidone (NMP). A dihydroxyalkylamine (a diethanolamine at 4.04 mL, 42.1 mmol.), then a halide salt (sodium iodide at 1.58 gram, 10.5 mmol.) were successively added to the swelled polystyrene. The solution can become brown upon addition of the sodium iodide. The vessel was shaken for about 48 hours at room temperature (the color turn pale brown). Then the solvent was filtered off and the resin was rinsed once with tetrahydrofuran (THF), three times with THF/water at a 2:1 ratio, three time with THF, and five times with methylene chloride. The resulting conjugated resin was dried under high vacuum for more than about 12 hours. This protocol gave a quantitative yield of DEAM-PS resin.

A small sample was further washed with THF (about seven times) and dried exhaustively to provide an analytical sample for chloride analysis. The elemental analysis revealed: N (0.88%) (calculated 0.84%); Cl (0.04%) (calculated 0.0%).

### Example 2

### Preparation of an N,N-diethanolaminomethyl Polystyrene

Chloromethyl polystyrene resin (3.00 g, 3.72 mmol, theor. loading: 1.24 mmol g⁻¹, 200-400 mesh) was weighed into a 70 ml polypropylene reaction vessel and swollen in dry NMP (32 mL). Diethanolamine (7.13 mL, 74.4 mmol) was added and the mixture was vortexed for a short time. NaI (2.79 g, 18.6 mmol) was added as a solid and the resin suspension was shaken at rt for >48 h. The reaction mixture was drained, and the resin was rinsed with 2:1 THF/H₂O (3×), 1:1 DMF/Et₃N (3×), dry THF (3×), and CH₂Cl₂ (5×). The resin was then dried under high vacuum for >24 h to afford a white resin (3.03 g, theoretical: 3.26 g, theor. loading: 1.14 mmol g⁻¹).

### Example 3

### Preparation of an N,N-diethanolaminomethyl Polystyrene

2-Chloroethanol is transformed in situ to the iodide derivative with sodium iodide. An amino group of cross-linked aminomethylated polystyrene displaces the iodides of two equivalents of 2-iodoethanol in a minimum quantity of N-methylpyrrolidinone at room temperature to provide N, N-diethanolaminomethyl polystyrene . While these conditions are promoted by an iodide (or equivalent) ion, they do not necessitate any pressure nor any rise of temperature. This new protocol provides DEAM-PS resin of high homogeneity and can be readily adapted to the preparation of large quantities of product, e.g., on a kilogram scale.

A dihydroxyalkylaminoalkyl-conjugated solid support is made by a process comprising the following steps. 1% divinylbenzene (DVB) cross-linked aminomethylated polystyrene (1.00 g at 80 mmol/g substitution, 0.8 mmol) are weighed out in a reaction vessel. NMP is added as a solvent. A halogenated alcohol (2-chloroethanol at 0.21 mL, 3.2 mmol, 4 equiv.), and a base (diisopropylethylamine, 0.56 mL, 3.2 mmol, 4 equiv.), then a halide salt (sodium iodide at 0.48 g, 3.2 mmol) are successively added to the polystyrene. The vessel is shaken for about 12-48 hours at room temperature. Then the solvent is filtered off and the resin is rinsed once with tetrahydrofuran (THF), three times with THF/water at a 2:1 ratio, three times with THF, and five times with methylene chloride. The resulting conjugated resin is dried under high vacuum. This protocol gives the DEAM-PS resin.

### Example 4

### Larger Scale Preparation of N,N-diethanolaminomethyl Polystyrene

Example 4 is identical to Example 2 except for the noted differences. All reagents are present at 100-fold the quantities as set out in Example 2. The reaction is carried out in a round bottom flask or an erlenmeer flask equipped with mechanical stirring.

### Example 5

### Typical Procedure for the Immobilization of a Boronic Acid to DEAM-PS

In FIG. 2, p-tolylboronic acid (20 mg, 0.152 mmol, 1.3 equiv) and anhydrous THF (1.5 mL) were added to DEAM-PS (102 mg, 0.117 mmol, 1 equiv, exper. loading: 1.15 mmol g⁻¹) in apolypropylene reaction vessel. The reaction suspension was shaken at rt for 1 h and the polypropylene vessel was drained. The resin was then washed with dry TBF (3×, 2 mL) and dried under high vacuum.

### Example 6

### Preparation of N,N-diisopropanolaminomethyl Polystyrene

The procedure is the same as that in example 2 for the preparation of N,N-diethanolaminomethyl polystyrene. Chloromethyl polystyrene resin (3.00 g, 3.72 mmol, theor. loading: 1.24 mmol g⁻¹, 200-400 mesh) is weighed into a 70 ml polypropylene reaction vessel and swollen in dry NMP (32 mL). Diisopropanolamine (9.9 mL, 75 mmol) is added and the mixture is vortexed for a short time. NaI (2.79 g, 18.6 mmol) is added as a solid and the resin suspension is shaken at rt for >48 h. The reaction mixture is drained, and the resin is rinsed with 2:1 THF/H₂O (3×), 1:1 DMF/Et₃N (3×), dry THF (3×), and CH₂Cl₂ (5×). The resin is then dried under high vacuum for >24 h.

### Example 7

### Examination of the Role of the Nitrogen in Dihydroxyalkylaminoalkyl-Conjugated Resins

FIG. 3a shows the gel-proton phase proton NMR spectra of the free form of DEAM-PS, while FIG. 3 B shows the NMR spectra of the p-tolylboronic acid conjugated form using a magic angle spinning nanoprobe.

By making abstraction of peaks from the polystyrene matrix, two broad singlets show up at 2.6 and 3.5 ppm in the spectrum of free DEAM-PS (A). The largest most unshielded peak contained resonances from both benzylamino and hydroxymethyl methylenes. Upon formation of a cis fused bicyclic diethanolamine boronate adduct whose two faces are non-equivalent, the ring hydrogens become diastereotopic. As expected, the resulting spectrum (B) showed extensive degeneration of the methylenic protons in the hydroxyethyl arms. As many as four peaks were now seen between 2.2 and 3.6 ppm, thereby lending support to a tetrahedral, nitrogen-coordinated boronic ester.

### Example 8

### Immobilization of Various Boronic Acids onto DEAM-PS

A series of boronic acids presenting different steric and electronic characteristics were tested as a means to evaluate the generality of immobilization onto DEAM-PS in Table 1. These studies were carried out under conditions planned to optimize the yield of immobilization. Thus, a slight excess of the boronic acid (ca. 1.3 equiv), pre-dried in vacuo as the monoanhydride form, was shaken with DEAM-PS at room temperature for 15 minutes. Percentages of recovery are based on the amount of boronic acid isolated after cleavage with water/THF (5:95). A solvent profile study using p-tolylboronic acid revealed that a wide range of anhydrous solvents can be employed (entries 1-6). Whereas THF was found to be a general solvent to solubilize and immobilize boronic acids efficiently, dichloromethane provides higher yields of immobilization (entries 5 vs 6). Presumably, the limited solubility of water in dichloromethane minimizes the back reaction (hydrolysis). When using THF as solvent, a wide variety of functionalized arylboronic acids presenting different steric and electronic characteristics were found to immobilize efficiently onto DEAM-PS (entries 6-18). With the exception of ortho-carboxyphenylbororic acid (entry 10) and exceptionally hindered or electron-poor arylboronic acids (entries 15, 16), the coupling yields were very high. Immobilization of alkenylboronic acids is also possible (entry 18). All these boronic acids were recovered intact and the leftover DEAM-PS resin can be recycled with no apparent loss of efficiency after neutralization with base (dilute triethylamine) followed by the usual rinses.

Hydroxylic solvents such as methanol and ethanol allow a dynamic transesterification process to take place, leading to non-quantitative immobilization (Table 1, entry 1). A control experiment was devised to measure the extent of transesterification of DEAM-PS supported p-tolylboronic acid in 7:1 THF/ethanol. Equilibrium was reached within 15 minutes of exposure of the supported p-tolylboronic acid to the 7:1 THF/ethanol solvent. Successive incubations of the resin under constant resin:solvent proportions, followed by rinses with dry THF, revealed that approximately 40% p-tolylboronic acid was released from the resin under these conditions. The reverse reaction gave a similar outcome under the same conditions, showing that the transesterification process is under equilibrium.

Immobilization and cleavage of p-tolylboronic acid from diisobutanolaminomethyl substituted resin showed similar results when carried out under similar conditions to results obtained with the DEAM-PS resin. The relative sensitivity of the diethanolamine boronic ester linkage to water and alcohols should be taken into account when using resins for the derivatization of functionalized boronic acids. Anhydrous and alcohol-free reaction conditions are most preferable to avoid premature cleavage of products.

TABLE 1
Immobilization of various boronic acids onto 1.^{a}

| entry | R | solvent | yield (%)^{b} | purity^{c} |
|---|---|---|---|---|
| 1 | 4-Me-C₆H₄ | MeOH | 72 | >95 |
| 2 | 4-Me-C₆H₄ | NMP | 80 | >95 |
| 3 | 4-Me-C₆H₄ | Et₂O | 90 | >95 |
| 4 | 4-Me-C₆H₄ | toluene | 88 | >95 |
| 5 | 4-Me-C₆H₄ | CH₂Cl₂ | 98 | >95 |
| 6 | 4-Me-C₆H₄ | THF | 89 | >95 |
| 7 | 4-Br—C₆H₄ | THF | 97 | >95 |
| 8 | 4-MeO-C₆H₄ | THF | 87 | >95 |
| 9 | 4-HO₂C—C₆H₄ | THF | 90 | >95 |
| 10 | 2-HO₂C—C₆H₄ | THF | 51 | >95 |
| 11 | 3-H₂N—C₆H₄ | THF | 91 | >95 |
| 12 | 2-CHO—C₆H₄ | THF | 98^{d} | >95 |
| 13 | 4-PhO—C₆H₄ | THF | 93 | >95 |
| 14 | 4-BrCH₂—C₆H₄ | THF | 85 | >95 |
| 15 | 2,6-di-Me-C₆H₃ | THF | 46 | >95 |
| 16 | 2,4-di-F—C₆H₃ | THF | 46 | >95 |
| 17 | 2-naph | THF | 89^{d} | >95 |
| 18 | (E)-PhCH═CH | THF | 81 | >95 |

^{a}Coupling reactions were conducted by shaking resin 1 (1 equiv, 120 mg, 1.15 mmol/g) with the boronic acid (1.3 equiv) in the indicated solvent (1.5 mL) at room temperature for 1 hour in a polypropylene fitted vessel.
^{b}Yields of boronic acid recovered after cleavage from the resin with 5% H₂O/THF for 1 min at rt and washed with 5% H₂O/THF (3 ×). The resin was rinsed with the reaction solvent (3 ×) prior to cleavage. For entries 4 and 5, additional THF rinses were carried out (3 ×). The reported yields are an average of mass balance and internal standardization (see Experimental Section for details) based on the loading of resin 1 measured by elemental analysis.
^{c}Estimated by comparison of ¹H NMR spectra of starting and recovered boronic acids.
^{d}Calculated only from mass balance, tendency of this boronic acid to form anhydrides made NMR quantitation difficult.

TABLE 2
Substitution reactions on 5 and 6.

| | sub- | | product | yield^{b} | purity^{c} |
|---|---|---|---|---|---|
| entry | strate | conditions^{a} | {R¹, R²} | (%) | (%) |
| 1 | 5 | A | 8a {H, CH₂Ph} | 69 | 95 |
| 2 | 5 | A | 8b {H, CH₂CH(CH₃)₂} | 50 | >90 |
| 3 | 5 | B | 8c {(CH₂)₂O(CH₂)₂} | 85 | 95 |
| 4 | 5 | B | 8d {Me, CH₂Ph} | 75 | >95 |
| 5 | 6 | A | 9a {H, CH₂Ph} | 69 | >90 |
| 6 | 6 | A | 9b {H, CH₂CH(CH₃)₂} | 53 | 95 |
| 7 | 6 | B | 9c {(CH₂)₂O(CH₂)₂} | 98 | >90 |
| 8 | 6 | B | 9d {Me, CH₂Ph} | 94 | 95 |

^{a}Reactions were carried out by shaking the supported benzyl bromide with the amine in NMP at rt for approx. 5 hours (typical scale 0.12 mmol 5-6). Conditions: A: 50 equiv of primary amine, use of low loading DEAM-PS resin (0.60 mmol/g). B: 10 equiv of secondary amine, use of either low loading (0.60 mmol/g) or high loading (1.14 mmol/g) DEAM-PS resin.
^{b}Non optimized yields of crude products after cleavage from the resin with 5% H₂O/THF and drying in vacuo for >12 hours. The reported values are an average of mass balance and internal standardization (see Experimental Section for details).
^{c}Estimated from ¹H and ¹³C NMR data.

TABLE 3
Reductive amination on aldehyde 11.

| | sub- | | product | yield^{b} | purity^{c} |
|---|---|---|---|---|---|
| entry | strate | conditions^{a} | {R¹, R²} | (%) | (%) |
| 1 | 11 | A | 7a {H,CH₂Ph} | 66 | >90 |
| 2 | 11 | A | 7b {H, CH₂CH(CH₃)₂} | 55 | >90 |
| 3 | 11 | A | 7c {H, (CH₂)₃Ph} | 62 | 95 |
| 4 | 11 | A | 7d {H, (CH₂)₃CH₃} | 73 | >95 |

^{a}Typical scale 0.1 mmol. A: Reactions were carried out by preforming the imine from supported aldehyde and the amine (2 equiv) in THF at rt for approx. 2.5 hours. Sodium borohydride was added and the suspension was shaken for approx. 4 hours.
^{b}Non optimized yields of crude products after cleavage from the resin with 5% H₂O/THF and drying in vacuo for >12 hours. The reported values are an average of mass balance and internal standardization (see Experimental Section for details).
^{c}Estimated from ¹H and ¹³C NMR data.

TABLE 4
Amide synthesis from 15 and 16.

| | sub- | | product | yield^{b} | purity^{c} |
|---|---|---|---|---|---|
| entry | strate | conditions^{a} | {R¹, R²} | (%) | (%) |
| 1 | 15 | A | 18a {H, (CH₂)₃Ph} | 57 | 95 |
| 2 | 15 | A | 18b {H, CH(CH₃)₂} | 60 | >90 |
| 3 | 15 | A | 18c {H, (CH₂)₃CH₃} | 56 | >90 |
| 4 | 15 | B | 18d {H, Ph} | 82 | >95 |
| 5 | 15 | A | 18e {Et, Et} | 77 | 90 |
| 6 | 15 | A | 18f {Bu, Bu} | 79 | 90 |
| 7 | 15 | A | 18g {CH₂Ph, CH₂Ph} | 60 | >90 |
| 8 | 16 | B | 19a {H, (CH₂)₃Ph} | 65 | >95 |
| 9 | 16 | B | 19b {H, CH(CH₃)₂) | 81 | >95 |
| 10 | 16 | A | 19c {H, (CH₂)₃CH₃} | 64 | 95 |
| 11 | 16 | A | 19d {H, Ph} | 67 | >95 |
| 12 | 16 | A | 19e {Et, Et} | 59 | >90 |
| 13 | 16 | A | 19f {Bu, Bu} | 53 | 90 |
| 14 | 16 | B | 19g {CH₂Ph, CH₂Ph} | 70 | 95 |
| 15 | 16 | A | 19h {H, CH₂CH₂NEt₂} | 70 | >95 |

^{a}Typical scale 0.1 mmol. A: Reactions were carried out by shaking the supported carboxylic acid with the amine (4 equiv), DIC (4 equiv) and HOBT-H₂O (4 equiv) in NMP or DMF at rt for 18 h. B: Reactions were carried out by shaking the supported carboxylic acid with the amine (2 equiv), DIPEA (4 equiv), and PyBOP (2 equiv) in DMF at rt for 20 h.
^{b}Non optimized yields of crude products after cleavage from the resin with 5% H₂O/THF and drying in vacuo for >12 hours. The reported values are an average of mass balance and internal standardization (see Experimental Section for details).
^{c}Estimated from ¹H and ¹³C NMR data.

TABLE 5
Anilide synthesis from anilines 20-22.^{a}

| | sub- | | product | yield^{b} | purity^{c} |
|---|---|---|---|---|---|
| entry | strate | conditions^{a} | {R¹, R²} | (%) | (%) |
| 1 | 20 | B | 23a {CH₂CH₃} | 61 | >95 |
| 2 | 20 | B | 23b {Ph} | 60 | >90 |
| 3 | 21 | A | 24a {CH₂CH₃} | 42 | >90 |
| 4 | 21 | A | 24b {Ph} | 52 | >95 |
| 5 | 21 | B | 24a {CH₂CH₃} | 72 | 95 |
| 6 | 21 | B | 24b {Ph} | 82 | 95 |
| 7 | 21 | B | 24c {CH₂CH₂CH═CH₂} | 70 | >95 |
| 8 | 21 | B | 24d {CCPh} | 75 | >95 |
| 9 | 21 | B | 24e {(S)CH(Me)NHFmoc} | 51 | 95 |
| 10 | 22 | B | 25a {CH₂CH₃} | 61 | >95 |
| 11 | 22 | B | 25b {Ph} | 46 | 95 |

^{a}Typical scale 0.1 mmol. A: Reactions were carried out by shaking the supported aniline with the carboxylic acid (2 equiv), DIC (2 equiv) and HOBT-H₂O (2 equiv) in DMF at rt for 20 h. B: Reactions were carried out by shaking the supported aniline with the carboxylic acid (2 equiv), PyBOP (2 equiv), DIPEA (4 equiv) in NMP at rt for 20 h.
^{b}Non optimized yields of crude products after cleavage from the resin with 5% H₂O/THF and drying in vacuo for >12 hours. The reported values are usually an average of mass balance and internal standardization (see Experimental Section for details).
^{c}Estimated from ¹H and ¹³C NMR data.

TABLE 6
Synthesis of ureas from anilines 21 and 22.

| | | | product | yield^{b} | purity^{c} |
|---|---|---|---|---|---|
| entry | substrate | conditions^{a} | {R} | (%) | (%) |
| 1 | 21 | B | 27a {CH(CH₃)₂} | 66 | 95 |
| 2 | 21 | A | 27b {Ph} | 79 | >95 |
| 3 | 21 | A | 27c {4-MeO-C₆H₄} | 82 | >95 |
| 4 | 21 | A | 27d {4-NO₂—C₆H_{4}} | 80 | >95 |
| 5 | 21 | A | 27e {Ph} | 85 | 95 |
| 6 | 22 | B | 28a {CH(CH₃)₂} | 65 | >95 |
| 7 | 22 | A | 28b {Ph} | 85 | >95 |
| 8 | 22 | A | 28c {4-MeO-C₆H₄} | 88 | >95 |
| 9 | 22 | A | 28d {4-NO₂—C₆H₄} | 92 | 95 |

^{a}Typical scale 0.1 mmol. A: Reactions were carried out by shaking the supported aniline with the isocyanate (2 equiv), in CH₂Cl₂ at rt for 5-6 h. B: longer reaction time (20-45 h).
^{b}Non optimized yields of crude products after cleavage from the resin with 5% H₂O/THF and drying in vacuo for >12 hours. The reported values are usually an average of mass balance and internal standardization (see Experimental Section for details).
^{c}Estimated from ¹H and ¹³C NMR data.

TABLE 7
Anhydrous Suzuki RRTR of 2a and 38. Effect of transfer agent
on conversion.^{a}

| | sol- | | transfer | temp. | time | conver- |
|---|---|---|---|---|---|---|
| entry | vent | base | agent | (° C.) | (h) | sion %^{d} |
| 1 | DMF | N(CH₂CH₂OH)₃^{b} | — | 105 | 20 | 40 |
| 2 | PhMe | N(CH₂CH₂OH)₃^{b} | — | 105 | 20 | 45 |
| 3 | diox- | NH(CH₂CH₂OH)₂^{b} | — | 85 | 20 | 45 |
| | ane | | | | | |
| 4 | DMF | Et₃N^{b} | (HOCH₂)₂^{b} | 105 | 20 | 100 |
| 5 | DMF | Et₃N^{c} | (HOCH₂)₂^{c} | 105 | 20 | 100 |
| 6 | DMF | Et₃N^{b} | (HOCH₂)₂^{b} | 85 | 20 | 100 |
| 7 | DMF | Et₃N^{c} | (HOCH₂)₂^{c} | 85 | 20 | 85 |

^{a}Typical trials were carried out with 40 mg of 38 (0.55 mmol/g) and 2 (4 equiv., 107 mg, 0.82 mmol/g) in 2 mL degassed solvent, and ca. 10-20 mol % Pd(PPh₃)₄ as catalyst.
^{b}A large excess is used, ca. 10% v/v.
^{c}20 equiv.
^{d}Measured by ¹H NMR integration of representative signals on crude reaction products.

TABLE 8
Anhydrous Suzuki RRTR of 2a and 38. Effect of base and temperature
under Pd₂(dba)₃ catalysis (50 mol %).^{a}

| entry | base | temp. (° C.) | conversion (%)^{b} | yield (%)^{c} |
|---|---|---|---|---|
| 1 | NaOH | 60 | —^{d} | 0_{d} |
| 2 | Ba(OH)₂ | 60 | —^{d} | 0^{d} |
| 3 | K₂CO₃ | 60 | —^{d} | 0^{d} |
| 4 | Cs₂CO₃ | 60 | —^{d} | 0^{d} |
| 5 | K₃PO₄ | 60 | —^{d} | 0^{d} |
| 6 | KF | 60 | >98 | >98 |
| 7 | KF | 25 | 78 | 74 |
| 8 | CsF | 60 | >98 | >98 |
| 9 | Et₃N | 60 | >98 | >98 |
| 10 | Et₃N | 25 | 72 | 71 |

^{a}Typical trials were carried out with 20 mg of 38 (0.55 mmol/g) and 2a (3.2 equiv, 45 mg, 0.79 mmol/g) with the indicated base (10 equiv) and 50 mol % Pd₂(dba)₃ as catalyst in DMF-ethylene glycol 10:1 (2.5 mL) for 18 h.
^{b}Measured by ¹H NMR integration of representative signals on crude reaction products.
^{c}Non optimized yields of crude products after cleavage from the resin and drying in vacuo for >12 hours. The reported values are usually an average of mass balance and internal standardization (see Experimental Section for details).
^{d}Premature cleavage.

TABLE 9
Anhydrous Suzuki RRTR of 2a and 38. Effect of base and catalyst at
high temperature (105° C.).^{a}

| entry | base | catalyst | conversion (%)^{b} | yield (%)^{c} |
|---|---|---|---|---|
| 1 | NaF | Pd₂(dba)₃ | 29 | 33 |
| 2 | TBAF | Pd₂(dba)₃ | >98 | <2 |
| 3 | CsF | Pd₂(dba)₃ | >98 | 3 |
| 4 | KF | Pd₂(dba)₃ | 93 | 65 |
| 5 | KF | PdCl₂(dppf) | >98 | 48 |
| 6 | Et₃N^{d} | Pd₂(dba)₃ | 42 | 58 |
| 7 | Et₃N^{d} | PdCl₂(dppf) | 81 | 63 |
| 8 | Et₃N^{d} | PdCl₂(dppf)^{e} | >98 | 64 |

^{a}Typical trials were carried out with 40 mg of 38 (0.98 mmol/g) and 2 (1.5 equiv, 58 mg, 1.07 mmol/g) with the indicated base (10 equiv) and catalyst (10 mol % Pd₂(dba)₃ or 20 mol % PdCl₂(dppf)) in DMF-ethylene glycol 10:1 (2.5 mL) at 105° C. for 20 h.
^{b}Measured by ¹H NMR integration of representative signals on crude reaction products.
^{c}Non optimized yields of crude products after cleavage from the resin and drying in vacuo for >12 hours. The reported values are based on internal standardization (see Experimental Section for details).
^{d}A large excess was used (0.25 mL)
^{e}The catalyst was added in two portions, one at the start, one after 8 h.

TABLE 10
Optimization of solvent system, at 65° C. for 24 h, for the
borono-Mannich RRTR of 48 and 2a to give 50a.^{a}

| entry | solvent | conversion (%)^{c} |
|---|---|---|
| 1 | 7:1 DMF/EtOH | 65 |
| 2 | 7:1 DMF/n-BuOH | 54 |
| 3 | 7:1 dioxane/n-BuOH | 23 |
| 4 | 7:1 THF/(HOCH₂)₂ | 37 |
| 5 | 7:1 THF/EtOH | 79 |

^{a}Preparation of resin substrates, RRTR trials, and subsequent cleavage of the resin mixture were carried out as indicated in the Experimental Section.
^{b}Based on the relative amounts of product and bis(trifluoroacetate) salt 51, calculated by integration of relevant signals by ¹H NMR after 24 h reaction time.

TABLE 11
Preparation of arylglycine derivatives by a borono-Mannich RRTR^{a}

| | amino | DEAM-PS- | | conver- | yield |
|---|---|---|---|---|---|
| entry | resin | boronate 2 | product | sion %^{b} | (%)^{c} |
| 1 | 48 | R═4-Me-C₆H₄ | 50^{a} | 79 | 85 |
| 2 | 48 | R═2-Me-C₆H₄ | 50^{b} | 81 | 73 |
| 3 | 48 | R═4-MeO-C₆H₄ | 50^{c} | 90 | >95 |
| 4 | 48 | R═4-Br-C₆H₄ | 50^{d} | 21 | 10 |
| 5 | 48 | R═1-Naph | 50^{e} | 85 | 90 |
| 6 | 48 | R═E-HC═CH(Bu) | 50^{f} | 89 | >95 |
| 7 | 52 | R═4-MeO-C₆H₄ | 54^{c} | 95 | 91 |
| 8 | 56 | R═4-MeO-C₆H₄ | 57^{c} | 76 | 82 |

^{a}Preparation of resin substrates, RRTR trials, and subsequent cleavage of the resin mixture were carried out as indicated in the Experimental Section.
^{b}Based on the relative amounts of product and respective bis(trifluoroacetate) salt 51, 55, or 58 calculated by integration of relevant signals by ¹H NMR after 24-48 h reaction time.
^{c}Yields of crude product based on ¹H NMR analysis with an internal standard.

A number of embodiments of the invention have been described. Nevertheless, it will be understood that various modifications may be made without departing from the spirit and scope of the invention. Accordingly, other embodiments are within the scope of the following claims.

What is claimed is:

1. A method for preparing a dihydroxyalklylaminoalkyl or a dihydroxyaminobenzyl-conjugated solid support under non-pressurized conditions comprising the following steps:
(a) providing an alkyl halide, a substituted alkyl halide or a benzyl halide conjugated to a solid support, wherein the alkyl halide has a formula —(CH₂)ₘ—X and m is an integer between 1 to about 20, and X is the halide and is chloride, bromide, iodide or an equivalent thereof;
(b) providing a composition comprising a secondary amine comprising two hydroxyalkyl substituents, wherein the composition has a formula HO(CH₂)ₓHN(CH₂)_{y}OH and x and y are integers between 1 to about 20;
(c) providing a halide salt selected from the group consisting of an iodide salt, a bromide salt and equivalents thereof; and,
(d) mixing the conjugated solid support of step (a) with the composition of step (b) and the halide salt of step (c) under non-pressurized conditions, thereby forming a dihydroxyalkylaminoalkyl or a dihydroxyaminobenzyl-conjugated solid support.

2. The method of claim 1, wherein the integer value of x and y of the amine of step (b) is 2.

3. The method of claim 1, wherein the integer value of x and y of the amine of step (b) is 3.

4. The method of claim 1, wherein the integer value of x and y of the amine of step (b) is 4.

5. The method of claim 1, wherein the integer value of x and y of the amine of step (b) is 5.

6. The method of claim 1, wherein the mixing step takes place at about room temperature.

7. The method of claim 1, wherein the alkyl halide of step (a) is methylchloride (ClCH₂—).

8. The method of claim 1, wherein the benzyl halide of step (a) is benzylchloride (ClCH₂C₆H₄—).

9. The method of claim 1, wherein the alkyl group of step (a) comprises the formula —(CH₂)ₘ—, wherein m is an integer between 2 to about 5.

10. The method of claim 1, wherein the composition of step (b) is diethanolamine or dipropanolamine or diisopropanolamine.

11. The method of claim 1, wherein the equivalents of amine in the composition of step (b) is in excess of the number of equivalents of alkyl halide, substituted alkyl halide or benzyl halide conjugated to a solid support in step (a).

12. The method of claim 1, wherein the equivalents of amine in the composition of step (b) is substantially equal to the number of equivalents of alkyl halide, substituted alkyl halide or benzyl halide conjugated to a solid support in step (a), and wherein a base is additionally present in the mixture of step (d).

13. The method of claim 12, wherein the base comprises a non-nucleophilic base.

14. The method of claim 13, wherein the base comprises diisopropylethylamine.

15. The method of claim 13, wherein the base comprises a carbonate.

16. The method of claim 1, wherein the composition of step (b) is in a solution comprising NMP, DMF, THF, DMSO, or an equivalent solution thereof.

17. The method of claim 1, wherein the halide salt of step (c) is added to the mixture of step (d) such that the initial amount of halide salt in the mixture is equimolar to or ten times the amount of alkyl halide or substituted alkyl halide or benzyl halide of step (a).

18. The method of claim 17, wherein the halide salt of step (c) is added to the mixture of step (d) such that the initial amount of halide salt in the mixture on a molar basis is two to five times the amount of alkyl halide or substituted alkyl halide or benzyl halide of step (a).

19. The method of claim 1, wherein the halide salt is a bromide salt.

20. The method of claim 1, wherein the halide salt is an iodide salt.

21. The method of claim 20, wherein the iodide salt comprises sodium iodide.

22. The method of claim 20, wherein the iodide salt comprises a tetraalkylammonium iodide salt.

23. The method of claim 1, wherein the solid support of step (a) comprises a polystyrene or an equivalent composition.

24. The method of claim 23, wherein the polystyrene comprises a poly(styrene-divinylbenzene) (PS-DVB) or an equivalent composition.

25. The method of claim 23, wherein the dihydroxyalkylaminoalkyl-conjugated polystyrene solid support is made by a process comprising the following steps:
(a) swelling the polystyrene with N-methyl-2-pyrrolidone (NMP) before reaction with the secondary amine;
(b) mixing the secondary amine and the halide salt with the swelled polystyrene.

26. The method of claim 1, wherein the solid support of step (a) comprises a plastic or a plastic co-polymer or an equivalent thereof.

27. The method of claim 1, wherein the solid support of step (a) comprises a polyphenol, a polyvinyl, a polypropylene, a polyester, a polyethylene, a polyethylene glycol, a polystyrene-copolymer, or an equivalent thereof, or a mixture thereof.

28. The method of claim 27, wherein the solid support of step (a) comprises a polystyrene-polyethylene glycol copolymer.

29. The method of claim 1, wherein the solid support of step (a) comprises a poly(vinyl alcohol) (PVA) hydrogel.

30. The method of claim 1, wherein the solid support of step (a) comprises a polyacrylamide or an equivalent polymer composition.

31. The method of claim 30, wherein the polyacrylamide comprises a polymethacrylamide, a methyl methacrylate, a glycidyl methacrylate, a dialkylaminoalkyl-(meth)acrylate, or a N,N-dialkylaminoalkyl(meth)acrylate, or an equivalent composition.

32. The method of claim 1, wherein the solid support of step (a) comprises an inorganic composition selected from the group consisting of sand, silica gel, glass, glass fibers, gold, alumina, zirconia, titania, and nickel oxide and combinations thereof and equivalents thereof.

33. The method of claim 32, wherein the diethanolaminoalkyl-conjugated group is covalently bonded to the solid support through a spacer group.

34. The method of claim 33, wherein the solid support comprises silica gel and the spacer group comprises an aryl-silane linker group.

35. The method of claim 1, wherein the mixing of step (d) lasts for about 48 hours.

36. The method of claim 1, wherein the mixing of step (d) lasts from about 12 to about 48 hours.

37. The method of claim 1, further comprising the step of washing the dihydroxyalkylaminoalkyl-conjugated solid support of step (d) at least once with at least one solvent.

38. The method of claim 37 wherein the solvent for washing comprises tetrahydrofuran, methylene chloride, dimethylformamide, dimethylsulfoxide, methanol, ethanol, or an equivalent thereof or a mixture thereof.

39. The method of claim 37, further comprising the step of washing the dihydroxyalkylaminoalkyl-conjugated solid support of step (d) with a tetrahydrofuran solution followed by washing with a methylene chloride solution.

40. A method for preparing a diethanolaminomethyl-conjugated solid support under non-pressurized conditions comprising the following steps:
(a) providing a chloromethylated polystyrene solid support;
(b) providing diethanolamine;
(c) providing a halide salt, wherein the halide salt comprises sodium iodide or an equivalent thereof; and,
(d) mixing the chloromethylated polystyrene solid support of step (a) with the diethanolamine of step (b) and the halide salt of step (c) under non-pressurized conditions, thereby forming the diethanolaminomethyl-conjugated solid support.

41. The method of claim 40, wherein the mixing step is at about room temperature.

42. A method for preparing a dihydroxyalkylaminoalkyl-conjugated solid support under non-pressurized conditions comprising the following steps:
(a) providing a solid support conjugated with a primary amino group;
(b) providing a composition comprising a halogenated alcohol, wherein the composition has a formula HO(CH₂)ₓY and x is an integer between 1 to about 20 and Y is a halide selected from the group consisting of chloride, bromide, and iodide and equivalents thereof;
(c) providing a halide salt selected from the group consisting of an iodide salt or a bromide salt or an equivalent thereof;
(d) providing a base; and
(e) mixing the conjugated solid support of step (a) with the composition of step (b) and the halide salt of step (c) and the base of step (d) under non-pressurized conditions, thereby forming a dihydroxyalkylaminoalkyl-conjugated solid support.

43. The method of claim 42, wherein the halogenated alcohol comprises 2-chloroethanol.

44. The method of claim 42, wherein the halogenated alcohol comprises 2-bromoethanol.

45. The method of claim 42, wherein the halogenated alcohol comprises 2-iodoethanol.

46. The method of claim 42, wherein the base comprises a non-nucleophilic base.

47. The method of any of claims 42 through 46, wherein the mixing step is at about room temperature.

48. A method for making a solid-supported boronic acid ester comprising the following steps:
(a) providing a conjugated solid support prepared by the following steps:
(i) providing an alkyl halide or a substituted alkyl halide or a benzyl halide conjugated to a solid support, wherein the alkyl halide has a formula —(CH₂)ₘ—X and m is an integer between 1 to about 20, and X is the halide and is chloride, bromide, iodide, or an equivalent thereof;
(ii) providing a composition comprising a secondary amine comprising two hydroxyalkyl substituents, wherein the composition has a formula HO(CH₂)ₓHN(CH₂)_{y}OH and x and y are integers between 1 to about 20;
(iii) providing a halide salt, wherein the halide salt is a bromide salt, an iodide salt, or an equivalent thereof; and,
(iv) mixing the conjugated solid support of step (i) with the composition of step (ii) and the halide salt of step (iii) under non-pressurized conditions, thereby forming a dihydroxyalkylaminoalkyl conjugate;
(b) providing a boronic acid solution; and
(c) mixing the dihydroxyalkylaminoalkyl-conjugated solid support of step (a) with the boronic acid solution of step (b), thereby forming a solid-supported boronic acid ester.

49. A method for immobilizing a boronic acid comprising the following steps:
(a) providing a conjugate prepared by the following steps:
(i) providing an alkyl halide or a substituted alkyl halide or a benzyl halide conjugated to an solid support, wherein the alkyl halide has a formula —(CH₂)ₘ—X and m is an integer between 1 to about 20 and the halide is chloride, bromide, iodide, or an equivalent thereof;
(ii) providing a composition comprising a secondary amine comprising two hydroxyalkyl substituents, wherein the composition has a formula HO(CH₂)ₓHN(CH₂)_{y}OH and x and y are integers between 1 to about 20;
(iii) providing a halide salt, wherein the halide salt is a bromide salt or an iodide salt, or an equivalent thereof; and,
(iv) mixing the conjugate of step (a) with the composition of step (b) and the halide salt of step (c) under non-pressurized conditions, thereby forming the conjugate;
(b) providing a boronic acid solution; and
(c) mixing the dihydroxyalkylaminoalkyl conjugate of step (a) with the boronic acid solution of step (b), thereby immobilizing the boronic acid.

50. The method of claim 48 or 49, wherein the integer value of x and y of the amine of step (a)(ii) is 2.

51. The method of claim 48 or 49, wherein the integer value of x and y of the amine of step (a)(ii) is 3.

52. The method of claim 48 or 49, wherein the integer value of x and y of the amine of step (a)(ii) is 4.

53. The method of claim 50 or 51, wherein the integer value of x and y of the amine of step (a)(ii) is 5.

54. The method of claim 50 or 51, wherein the solution of step (b) comprises a non-alcoholic, anhydrous solvent.

55. A method for preparing a conjugated resin comprising the following steps:
(a) providing an alkyl halide or a substituted alkyl halide or a benzyl halide conjugated to an resin, wherein the alkyl halide has a formula —(CH₂)ₘ—X and m is an integer between 1 to about 20,and the halide is chloride, bromide, iodide, or an equivalent thereof;
(b) providing a composition comprising a secondary amine comprising two hydroxyalkyl substituents, wherein the composition has a formula HO(CH₂)ₓHN(CH₂)_{y}OH and x and y are integers between 1 to about 20;
(c) providing a halide salt, wherein the halide salt is a bromide salt or an iodide salt or an equivalent thereof; and,
(d) mixing the conjugated resin of step (a) with the composition of step (b) and the halide salt of step (c) under non-pressurized conditions, thereby forming a dihydroxyalkylaminoalkyl-conjugated resin.

56. A method for preparing a conjugated polystyrene bead comprising the following steps:
(a) providing an alkyl halide or a substituted alkyl halide or a benzyl halide conjugated to a polystyrene bead, wherein the alkyl halide has a formula —(CH₂)ₘ—X and m is an integer between 1 to about 20, and the halide is chloride, bromide, iodide, or an equivalent thereof;
(b) providing a composition comprising a secondary amine comprising two hydroxyalkyl substituents, wherein the composition has a formula HO(CH₂)ₓHN(CH₂)_{y}OH and x and y are integers between 1 to about 20;
(c) providing a halide salt, wherein the halide salt is a bromide salt or an iodide salt or an equivalent thereof; and,
(d) mixing the conjugated polystyrene bead of step (a) with the composition of step (b) and the halide salt of step (c) under non-pressurized conditions for about 24 to about 48 hours, thereby forming the dihydroxyalkylaminoalkyl-conjugated polystyrene beads.

57. A method for preparing a dihydroxyalkylaminoalkyl-conjugated scavenger resin comprising the following steps:
(a) providing an alkyl halide or a substituted alkyl halide or a benzyl halide conjugated to a resin, wherein the alkyl halide has a formula —(CH₂)ₘ—X and m is an integer between 1 to about 20, and the halide is chloride, bromide, iodide, or an equivalent thereof;
(b) providing a composition comprising a secondary amine comprising two hydroxyalkyl substituents, wherein the composition has a formula HO(CH₂)ₓHN(CH₂)_{y}OH and x and y are integers between 1 to about 20;
(c) providing a halide salt, wherein the halide salt is a bromide salt or an iodide salt or an equivalent thereof; and,
(d) mixing the conjugated resin of step (a) with the composition of step (b) and the halide salt of step (c) under non-pressurized conditions, thereby forming a dihydroxyalkylaminoalkyl-conjugated scavenger resin.

58. The method of claims 55 through 57, wherein the iodide salt comprises sodium iodide.

59. The method of claims 55 through 57, wherein the iodide salt comprises a tetraalkylammonium iodide salt.

60. The method of claims 55 through 57, wherein the mixing step (d) takes place at about room temperature.

61. A solid support derivatized with a dihydroxyalkylaminoalkyl group wherein the dihydroxyalkylaminoalkyl comprises a tertiary amine having two hydroxyalkyl substituents having a formula HO(CH₂)ₓN (CH₂)_{y}OH, wherein x and y are integers between 1 to about 20.

62. The solid support of claim 64, wherein the dihydroxyalkylaminoalkyl is a dihydroxyalkylaminomethyl group, a dihydroxyalkylaminoethyl, a dihydroxyalkylaminopropyl, or a dihydroxyalkylaminobutyl group.

63. The solid support of claim 61, wherein the solid support comprises one of the following:
i. a polystyrene or an equivalent composition;
ii. a plastic or a plastic co-polymer or an equivalent thereof;
iii. a silica or a silica gel or an equivalent thereof;
iv. cellulose or cellulose acetate or an equivalent thereof;
v. a polyphenol, a polyvinyl, a polypropylene, a polyester, a polyethylene, a polyethylene glycol, a polystyrene-copolymer, or an equivalent thereof, or a co-polymeric mixture thereof;
vi. a poly(vinyl alcohol) (PVA) hydrogel, or an equivalent composition;
vii. a polyacrylamide or an equivalent polymer composition.

64. The solid support of claim 63, wherein the polyacrylamide comprises a polymethacrylamide, a methyl methacrylate, a glycidyl methacrylate, a dialkylaminoalkyl-(meth)acrylate, or an N,N-dialkylaminoalkyl(meth)acrylate, or an equivalent composition.

65. The solid support of claim 63, wherein the polystyrene is a poly(styrene-divinylbenzene) (PS-DVB) or an equivalent composition.

66. The solid support of claim 61, further comprising a boronic acid attached as a boronic ester-dioxyalkylaminoalkyl-conjugated support.

67. The solid support of claim 66, wherein the boronic acid is an aryl boronic acid, a vinylboronic acid or an alkylboronic acid.

68. The use of an iodide or bromide salt for the formation under non-pressurized conditions of a dihydroxyalkylaminoalkyl-conjugated solid support from an alkyl halide, a substituted alkyl halide or a benzyl halide conjugated to a solid support and a secondary amine comprising two hydroxyalkyl substituents, wherein the secondary amine has a formula HO(CH₂)ₓHN(CH₂)_{y}OH and x and y are integers between 1 to about 20.

69. The use of claim 68, wherein the alkyl halide, substituted alkyl halide or benzyl halide conjugated to a solid support is converted in situ to the iodide or the bromide, which is subsequently displaced by the secondary amine to yield the dihydroxyalkylaminoalkyl-conjugated solid support.

70. The use of claim 69, wherein the formation is at room temperature.

71. The use of claim 70, wherein the halide salt comprises sodium iodide.

72. A method for preparing a conjugated support under non-pressurized conditions comprising the following steps:
(a) providing an alkyl halide, a substituted alkyl halide or a benzyl halide conjugated to a solid support, wherein the alkyl halide has a formula —(CH₂)ₘ—X and m is an integer between 1 to about 20, and the halide is chloride, bromide, iodide or an equivalent thereof;
(b) providing a composition comprising a secondary amine comprising two hydroxyalkyl substituents, wherein the composition has a formula HO(CH₂)ₓHN(CH₂)_{y}OH and x and y are integers between 1 to about 20;
(c) providing a halide salt selected from the group consisting of an iodide salt, a bromide salt and equivalents thereof; and,
(d) mixing the conjugated solid support of step (a) with the composition of step (b) and the halide salt of step (c) under non-pressurized conditions, thereby forming a dihydroxyalkylaminoalkyl or a dihydroxyaminobenzyl-conjugated solid support.

73. The method of claim 1, wherein the mixing step takes place at about room temperature.
